(19) United States
(12) Patent Application Publication
(10) Pub. No.: US 2026/0291416 A1
(43) Pub. Date: Sep. 24, 2026

(54) ESTABLISHMENT METHOD FOR ANALYSIS MODEL OF MOTOR AND CONTROL METHOD BASED ON VECTOR MAGNETIC CIRCUIT COORDINATE TRANSFORMATION

(71) Applicants: SOUTHEAST UNIVERSITY, Nanjing (CN); NORTH CHINA ELECTRIC POWER UNIVERSITY(BAODING), Baoding (CN)

(72) Inventors: Ming CHENG, Nanjing (CN); Xinkai ZHU, Baoding (CN); Wei QIN, Nanjing (CN); Changhao SONG, Baoding (CN); Dajun ZHAO, Baoding (CN); Runqian LI, Baoding (CN)

(21) Appl. No.: 19/670,259

(22) Filed: May 7, 2026

Related U.S. Application Data
(63) Continuation of application No. PCT/CN2025/071967, filed on Jan. 13, 2025.

(30) Foreign Application Priority Data
Dec. 23, 2024 (CN) 202411898586.8

(51) Int. Cl. H02P 21/13; H02P 21/18; H02P 21/24

(52) U.S. Cl. CPC H02P 21/13; H02P 21/18; H02P 21/24; H02P 2207/055

(57) ABSTRACT

According to an establishment method for an analysis model of a motor and a control method based on vector magnetic circuit coordinate transformation, vector magnetic circuit models of a surface permanent magnet synchronous motor (SPMSM) are established, an arctangent value of a ratio of equivalent magnetic inductive reactance to reluctance is taken as a magnetic impedance angle, the magnetic impedance angle is introduced to characterize influences of eddy-current and hysteresis effects on motor performance and control, and an R-L coordinate transformation and an R-L coordinate system is proposed based on vector magnetic circuit; and an analysis model of the SPMSM is established based on a vector magnetic circuit and the R-L coordinate system. In the present disclosure, the iron loss effect can be fully considered, and the method is simple and convenient with clear physical significance, which can effectively improve the rotor position identification accuracy of sensorless control.

### CROSS-REFERENCE TO RELATED APPLICATIONS

This application is a continuation of PCT/CN2025/071967, filed on Jan. 13, 2025 and claims priority of Chinese Patent Application No. 202411898586.8, filed on Dec. 23, 2024, the entire contents of which are incorporated herein by reference.

### TECHNICAL FIELD

The present disclosure relates to the technical field of motor control, and particularly to an establishment method for an analysis model of a motor and a control method based on vector magnetic circuit coordinate transformation.

### BACKGROUND

Surface permanent magnet synchronous motors (SPMSMs) offer the advantages of a simple structure, high power density, wide speed regulation range, and high working efficiency. Furthermore, these motors are widely used in industries such as industrial manufacturing, electric vehicles, and home appliances. SPMSM performance is not only affected by the motor structure but is also critically influenced by control algorithms, among which vector control is one of the most common control methods for SPMSMs. Vector control requires mechanical sensors to provide position information, but sensors inevitably face problems such as hardware failure, reduced reliability, space occupation, and increased cost. To solve and overcome these problems, a position sensorless control strategy has emerged.

In the sensorless control, because the rotor position and speed information is estimated according to the relationship between voltage and current, the motor model plays an important role, and it is important to establish a more accurate analysis model of permanent magnet synchronous motor (PMSM). Iron losses (caused by eddy current and hysteresis) are inevitable in the operation of motor. However, most research on sensorless control of SPMSM is carried out without considering the influence of iron losses. The performance of sensorless control system of SPMSM is affected by the traditional analysis model which does not consider the effect of iron losses, especially when the motor is running at high speed.

Professor Ming Cheng's research team at Southeast University has discovered the phenomena of magductance and hysteretance in magnetic circuit, has established the vector magnetic circuit theory and the law of magnetoelectric power, which includes three elements of reluctance-magductance-hysteretance, and has provided a new method for taking the iron loss of motor into account, which is different from using the equivalent resistance to consider the iron loss. The active loss caused by a magductance element corresponds to the eddy-current loss in the magnetic circuit, and the active loss caused by a hysteretance element corresponds to the hysteresis loss in the magnetic circuit. When magductance and hysteretance are introduced into a PMSM model, the influences of the eddy-current and hysteresis effects causing iron loss on the permanent magnet flux and the stator flux excited by the armature current can be considered. Based on vector magnetic circuit theory, a new PMSM analysis model and control method can be established. The model considers both the magnetic circuit and the electric circuit, which makes the introduction of iron loss more reasonable, but its form is also more complex. In the analysis model, the coupling of direct-axis (d-axis) current and quadrature-axis (q-axis) flux and the coupling of q-axis current and d-axis flux are introduced in the flux equation, and the differential coupling term of d-axis current and q-axis current and the rotating electromotive force component are added in the voltage equation. The addition of these coupling terms makes the motor model closer to the real operating conditions of the motor, but increases the design difficulty of the sensorless control system for the motor.

### SUMMARY

An objective of the present disclosure is to provide a coordinate transformation and a surface permanent magnet synchronous motor (SPMSM) analysis model based on a vector magnetic circuit, and to provide a motor control method based on the motor analysis model.

The present disclosure provides a method for establishing an analysis model of an SPMSM, including the steps of: introducing magductance [symbol] and hysteretance C into direct-axis (d-axis) and quadrature-axis (q-axis) magnetic circuit models of an SPMSM to construct d-axis and q-axis vector magnetic circuit models; taking an arctangent of a ratio between equivalent magnetic inductive reactance ω [symbol] and reluctance [symbol] as a magnetic impedance angle δ of the SPMSM; and taking the magnetic impedance angle to characterize influences of eddy-current and hysteresis effects causing iron loss on stator flux linkage and permanent magnet flux linkage;
proposing an R-L coordinate system and an R-L coordinate transformation matrix

$${T}_{δ}^{′} ;$$

the R-L coordinate system lagging behind a direct-quadrature (d-q) coordinate system by a magnetic impedance angle δ; and establishing an analysis model of the SPMSM based on a vector magnetic circuit and the R-L coordinate system, including flux linkage equations and voltage equations based on the vector magnetic circuit and the R-L coordinate system.

Furthermore, the magnetic impedance angle δ of the SPMSM is expressed as:

$$δ = arctan ( \frac{{ωℒ}_{e q}}{\text{?}} ) = arctan ( \frac{ωℒ + \frac{1}{ω C}}{\text{?}} ) \qquad ( 1 )$$

an expression is defined as:

$$k = \frac{{ℒ}_{e q}}{{N}^{2}} = \frac{ℒ + \frac{1}{{ω}^{2} C}}{{N}^{2}} \qquad ( 2 )$$

k is an equivalent magductance coefficient;
since the reluctance is expressed as

$$\text{?} = \frac{{N}^{2}}{{L}_{s}} ;$$

the magnetic impedance angle of the SPMSM is expressed as:

$$δ = arctan ( ω {L}_{s} k ) \qquad ( 3 )$$

where [symbol] is magductance in the d-q coordinate system, C is hysteretance in the d-q coordinate system, [symbol] is equivalent magductance in the d-q coordinate system, [symbol] is reluctance in the d-q coordinate system, Lₛ is inductance in the d-q coordinate system, k is the equivalent magductance coefficient, δ is the magnetic impedance angle, ω is electrical angular velocity of the rotor, and N is the number of turns of armature winding.

Furthermore, the R-L coordinate transformation matrix

$${T}_{δ}^{′}$$

is expressed as:

$${T}_{δ}^{′} = [ \begin{matrix}cos δ & - sin δ \\ sin δ & cos δ\end{matrix} ] .$$

Furthermore, a flux linkage equation of the SPMSM based on a vector magnetic circuit in the d-q coordinate system is obtained as:

$$[ \begin{matrix}1 & - tan δ \\ tan δ & 1\end{matrix} ] [ \begin{matrix}{ψ}_{d} \\ {ψ}_{q}\end{matrix} ] = [ \begin{matrix}{L}_{s} & 0 \\ 0 & {L}_{s}\end{matrix} ] [ \begin{matrix}{i}_{d} \\ {i}_{q}\end{matrix} ] + [ \begin{matrix}{ψ}_{f} \\ 0\end{matrix} ] \qquad ( 6 )$$

two sides of Equation (6) are multiplied by cos δ, and the flux linkage equation of the SPMSM based on the vector magnetic circuit in the d-q coordinate system is also written as:

$${T}_{δ}^{′} [ \begin{matrix}{ψ}_{d} \\ {ψ}_{q}\end{matrix} ] = [ \begin{matrix}{L}_{s} cos δ & 0 \\ 0 & {L}_{s} cos δ\end{matrix} ] [ \begin{matrix}{i}_{d} \\ {i}_{q}\end{matrix} ] + [ \begin{matrix}{ψ}_{f} cos δ \\ 0\end{matrix} ] \qquad ( 7 )$$

transforming d-axis and q-axis flux linkages by the R-L coordinate transformation matrix

$${T}_{δ}^{′}$$

to obtain R-axis and L-axis flux linkages; and

$$[ \begin{matrix}{ψ}_{\text{?}} \\ {ψ}_{ℒ}\end{matrix} ] = {T}_{δ}^{′} [ \begin{matrix}{ψ}_{d} \\ {ψ}_{q}\end{matrix} ]$$

from Equation (7), a flux linkage equation of the SPMSM based on the vector magnetic circuit and the R-L coordinate system is obtained as:

$$[ \begin{matrix}{ψ}_{\text{?}} \\ {ψ}_{ℒ}\end{matrix} ] = [ \begin{matrix}{L}_{s} cos δ & 0 \\ 0 & {L}_{s} cos δ\end{matrix} ] [ \begin{matrix}{i}_{d} \\ {i}_{q}\end{matrix} ] + [ \begin{matrix}{ψ}_{f} cos δ \\ 0\end{matrix} ] . \qquad ( 8 )$$

Furthermore, a voltage equation of the SPMSM in the R-L coordinate system is as follows:

$$[ \begin{matrix}{u}_{\text{?}} \\ {u}_{ℒ}\end{matrix} ] = [ \begin{matrix}{R}_{s} & 0 \\ 0 & {R}_{s}\end{matrix} ] [ \begin{matrix}{i}_{\text{?}} \\ {i}_{ℒ}\end{matrix} ] + [ \begin{matrix}p {ψ}_{\text{?}} \\ p {ψ}_{ℒ}\end{matrix} ] + [ \begin{matrix}- {ωψ}_{ℒ} \\ ω {ψ}_{\text{?}}\end{matrix} ] . \qquad ( 9 )$$

R-axis and L-axis currents are used to replace d-axis and q-axis currents according to a relation of

$$[ \begin{matrix}{i}_{\text{?}} \\ {i}_{ℒ}\end{matrix} ] = {T}_{δ}^{′} [ \begin{matrix}{i}_{d} \\ {i}_{q}\end{matrix} ]$$

and Equation (8), and the R-axis and L-axis flux linkages are expressed by the d-axis and q-axis currents, which is obtained from Equation (9):

$$[ \text{} \begin{matrix}{u}_{\text{?}} \\ {u}_{ℒ}\end{matrix} ] = [ \text{} \begin{matrix}{R}_{s} cos δ + p {L}_{s} cos δ & - ( {R}_{s} sin δ + ω {L}_{s} cos δ \\ {R}_{s} sin δ + {ωL}_{s} cos δ & R cos δ + pL cos δ\end{matrix} ] [ \text{} \begin{matrix}{i}_{d} \\ {i}_{q}\end{matrix} ] + [ \text{} \begin{matrix}0 \\ ω {ψ}_{f} cos δ\end{matrix} ] \text{} \qquad ( 10 )$$

since Rₛ sin δ<<ωLₛ cos δ, Rₛ sin δ in Equation (10) is neglected, and according to Equation (10), a voltage equation of the SPMSM based on the vector magnetic circuit and the R-L coordinate system is obtained as:

$$\frac{1}{cos δ} [ \begin{matrix}{u}_{\text{?}} \\ {u}_{ℒ}\end{matrix} ] = [ \begin{matrix}{R}_{s} + p {L}_{s} & - ω {L}_{s} \\ ω {L}_{s} & {R}_{s} + p {L}_{s}\end{matrix} ] [ \begin{matrix}{i}_{d} \\ {i}_{q}\end{matrix} ] + [ \begin{matrix}0 \\ ω {ψ}_{f}\end{matrix} ] \qquad ( 11 )$$

where [symbol] and [symbol] are flux linkages in the R-L coordinate system, [symbol] and [symbol] are voltages in the R-L coordinate system, [symbol] and [symbol] are currents in the R-L coordinate system, Lₛ is the inductance in the d-q coordinate system, Rₛ is resistance in the d-q coordinate system, ψ_{f} is permanent magnet flux linkage, δ is the magnetic impedance angle, ω is the electrical angular velocity of the rotor, and p is a differential operator.

Furthermore, a voltage term on a left side of Equation (10) is expressed in the d-q coordinate system, and a voltage equation of the SPMSM based on the vector magnetic circuit in the d-q coordinate system is obtained as:

$$[ \begin{matrix}1 & - tan δ \\ tan δ & 1\end{matrix} ] [ \begin{matrix}{u}_{d} \\ {u}_{q}\end{matrix} ] = [ \begin{matrix}{R}_{s} + p {L}_{s} & - ω {L}_{s} \\ ω {L}_{s} & {R}_{s} + p {L}_{s}\end{matrix} ] [ \begin{matrix}{i}_{d} \\ {i}_{q}\end{matrix} ] + [ \begin{matrix}0 \\ ω {ψ}_{f}\end{matrix} ] \qquad ( 12 )$$

an inverse Clark transformation is performed on Equation (12), and a voltage equation of the SPMSM based on the vector magnetic circuit in an a-β coordinate system is obtained as:

$$[ \begin{matrix}1 & - tan δ \\ tan δ & 1\end{matrix} ] [ \begin{matrix}{u}_{α} \\ {u}_{β}\end{matrix} ] = [ \begin{matrix}{R}_{s} + p {L}_{s} & 0 \\ 0 & {R}_{s} + p {L}_{s}\end{matrix} ] [ \begin{matrix}{i}_{α} \\ {i}_{β}\end{matrix} ] + [ \begin{matrix}- {ωψ}_{f} sin θ \\ ω {ψ}_{f} cos θ\end{matrix} ] \qquad ( 13 )$$

where i_{α} and i_{β} are currents in the a-β coordinate system, u_{d} and u_{q} are voltages in the d-q coordinate system, and θ is an electrical angle of a rotor position.

Based on the analysis model of an SPMSM of the present disclosure, the present disclosure also provides a sensorless control method for an SPMSM based on the vector magnetic circuit and the R-L coordinate system, including the steps of:
sampling three-phase currents of the motor to obtain sampling values

$${i}_{a}^{*} , {i}_{b}^{*} , and {i}_{c}^{*} ,$$

passing

$${i}_{a}^{*} , {i}_{b}^{*} , and {i}_{c}^{*}$$

through a Clark transformation module to obtain current sampling values

$${i}_{α}^{*} and {i}_{β}^{*}$$

in the a-β coordinate system, and passing

$${i}_{α}^{*} and {i}_{β}^{*}$$

through a Park transformation module to obtain current sampling values

$${i}_{d}^{*} and {i}_{q}^{*}$$

in the d-q coordinate system; processing an error between an observed rotor speed value \hat{n} and a set value n through a proportional-integral (PI) controller to obtain d-axis and q-axis current set values i_{d} and i_{q}, inputting errors between

$${i}_{d}^{*}$$

with

$${i}_{q}^{*}$$

and i_{d} with i_{q} into two PI controllers to obtain voltage set values [symbol] and [symbol] in the R-L coordinate system; performing an inverse Park transformation via an inverse Park transformation module based on an angle \hat{θ}−δ, transforming the voltage set values [symbol] and [symbol] in the R-L coordinate system to obtain voltage set values u_{α} and u_{β} in the a-β coordinate system; and synthesizing a voltage space vector using u_{α} and u_{β}, inputting the voltage space vector into a space vector pulse width modulation module (SVPWM) module for modulation, outputting state coding values of three half-bridges at the moment, and controlling the metal-oxide-semiconductor field-effect transistor (MOSFET) switches of a three-phase inverter to control the motor, where \hat{θ} is an observed rotor position angle value;
outputting the observed rotor speed value \hat{n} and the observed rotor position angle value \hat{θ} from a rotor position and sliding mode observer (SMO);
inputting a voltage

$$[ \begin{matrix}1 & - tan δ \\ tan δ & 1\end{matrix} ] [ \begin{matrix}{u}_{α} \\ {u}_{β}\end{matrix} ]$$

into the rotor position and SMO; and
inputting current sampling values

$${i}_{α}^{*} and {i}_{β}^{*}$$

in the a-β coordinate system into the rotor position and SMO.

Compared with the existing model, the above model has the following technical effects.
(1) In the present disclosure, the motor analysis model based on equivalent magnetic-sensing parameters and taking into account the effect of iron loss can reflect the influences of eddy current and hysteresis effects causing iron loss on motor performance and control, which is closer to the actual operating conditions of the motor and achieves higher accuracy in both analysis and control.
(2) The vector control based on the present disclosure corrects the voltage according to the magnetic impedance angle during inverse Park transformation, enhances the decoupling degree of the d-axis and q-axis current loops, accelerates the step response of the SPMSM, stabilizes the current waveform, and thereby improves the performance of vector control.
(3) Different from the traditional method of equating iron loss with resistance, the motor analysis model proposed by the present disclosure, which accounts for the effect of iron loss by using equivalent magductance parameters, is derived by simultaneously considering the relationships between the magnetic circuit and the electric circuit, thus providing a more theoretical basis for the introduction of iron loss. Compared with models that account for iron loss by means of resistance, the proposed model is simpler and similar in form to the traditional SPMSM analysis model that neglects iron loss effects. The conventional sensorless control method for the SPMSM can be applied to the proposed analysis model after simple modification, thereby enabling the design of a sensorless control system with higher control accuracy.

### BRIEF DESCRIPTION OF THE DRAWINGS

To explain the technical solutions of the present disclosure more clearly, the accompanying drawings required for use in the description of the examples are introduced briefly below.

FIG. 1 is a flow chart of the method of the present disclosure;

FIG. 2 is a schematic diagram of an R-L coordinate system established by the present disclosure;

FIG. 3 is a block diagram of a sensorless control method based on vector magnetic circuit and the R-L coordinate system of the present disclosure;

FIG. 4 is a simulation effect diagram of a control method of the present disclosure;

FIG. 5 is a simulation effect diagram of sensorless control at a rotational speed of 1,200 r/min of the present disclosure; and

FIG. 6 is a simulation effect diagram of sensorless control at a rotational speed of 3,000 r/min of the present disclosure.

### DETAILED DESCRIPTION

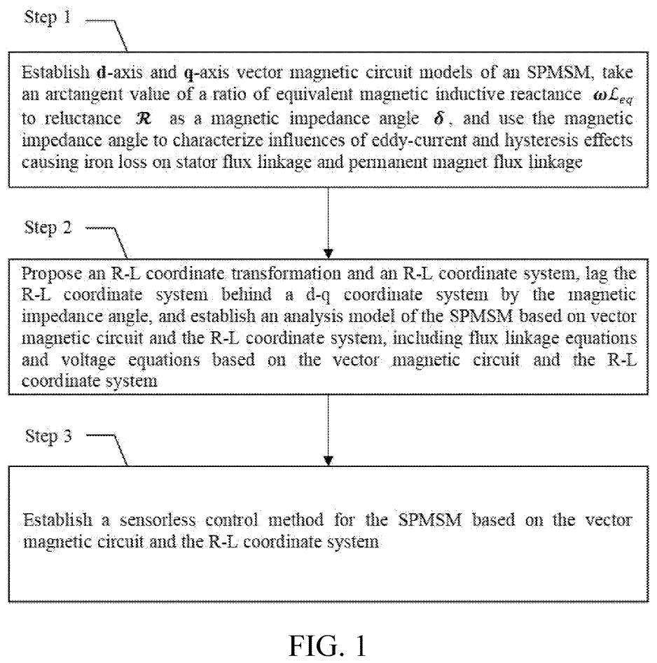

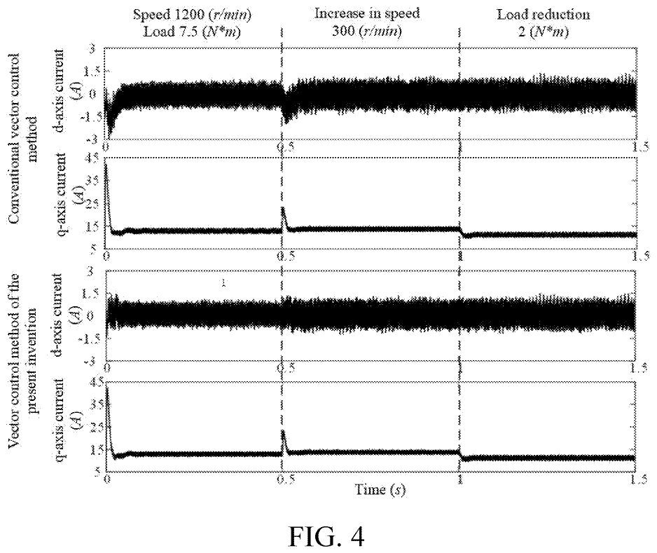

FIGS. 1-3 are specific examples of a vector magnetic circuit coordinate transformation and a method for establishing an analysis model of a motor and a control method according to the present disclosure, and FIGS. 4-6 are simulation results of specific examples to verify the effectiveness of the present disclosure. All the described examples are only some, rather than all examples of the present disclosure. Based on the examples in the present disclosure, all other examples obtained by those ordinary skilled in the art without creative efforts belong to the protection scope of the present disclosure.

The present disclosure provides a coordinate transformation based on vector magnetic circuit and an analysis and control method for a surface permanent magnet synchronous motor (SPMSM), including the following steps.

In step 1: direct-axis (d-axis) and quadrature-axis (q-axis) vector magnetic circuit models of an SPMSM are established, an arctangent value of a ratio of equivalent magnetic inductive reactance to reluctance [symbol] is taken as a magnetic impedance angle, and the magnetic impedance angle is used to characterize influences of eddy-current and hysteresis effects causing iron loss on stator flux linkage and permanent magnet flux linkage.

Two vector magnetic circuit parameters, namely magductance [symbol] and hysteretance C, are introduced into the d-axis and q-axis magnetic circuit model of the SPMSM, and the d-axis and q-axis vector magnetic circuit model is constructed. Magductance [symbol] and hysteretance C are used to characterize the magnitudes of the eddy-current and hysteresis effects that induce iron loss. Both magductance [symbol] and hysteretance C cause the magnetic flux to lag behind the magnetomotive force or the current, the equivalent magductance parameter [symbol] can be used to equivalent the combined effect of magductance [symbol] and hysteretance C, and the influence of iron loss is taken into account. In the d-axis and q-axis vector magnetic circuit model, the angle by which the magnetic flux lags behind the magnetomotive force or the current is defined as the magnetic impedance angle δ, which can be expressed as:

$$δ = arctan ( \frac{{ωℒ}_{e q}}{\text{?}} ) = arctan ( \frac{ωℒ + \frac{1}{ω C}}{\text{?}} ) \qquad ( 1 )$$

an expression is defined as:

$$k = \frac{{ℒ}_{e q}}{{N}^{2}} = \frac{ℒ + \frac{1}{{ω}^{2} C}}{{N}^{2}} \qquad ( 2 )$$

the parameter k is referred to as the equivalent magductance coefficient, which can be obtained through experiments. In the present disclosure, the variation of the equivalent magductance coefficient is not considered, and the equivalent magductance coefficient is regarded as a constant parameter. Since the reluctance can be expressed as

$$\text{?} = \frac{{N}^{2}}{{L}_{s}} ,$$

the magnetic impedance angle of the SPMSM can be expressed as:

$$δ = arctan ( ω {L}_{s} k ) . \qquad ( 3 )$$

In Equations (1-3), [symbol] is magductance in the direct-quadrature (d-q) coordinate system, C is hysteretance in the d-q coordinate system, [symbol] is equivalent magductance in the d-q coordinate system, [symbol] is reluctance in the d-q coordinate system, Lₛ is inductance in the d-q coordinate system, k is the equivalent magductance coefficient, δ is the magnetic impedance angle, ω is electrical angular velocity of the rotor, and N is the number of turns of armature winding.

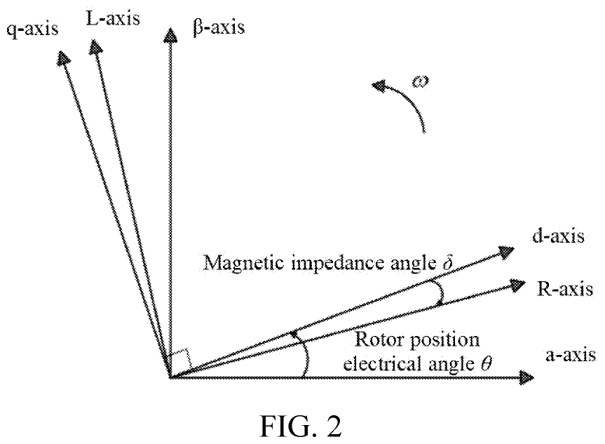

In step 2: an R-L coordinate transformation and an R-L coordinate system are proposed. As shown in FIG. 2, the R-L coordinate system lags behind the d-q coordinate system by a magnetic impedance angle. An analysis model for the SPMSM is established based on the vector magnetic circuit and the R-L coordinate system, which includes flux linkage equations and voltage equations based on the vector magnetic circuit and the R-L coordinate system.

The equivalent magductance parameter [symbol] is introduced into the d-axis and q-axis magnetic circuit equations of the SPMSM, and Park transformation is performed to obtain the d-axis and q-axis magnetic circuit equations in the d-q coordinate system:

$$\{ \begin{matrix}{ℱ}_{d} = {\text{?}}_{s} {Φ}_{d} + {ℒ}_{e q} p {Φ}_{d} - {ωℒ}_{e q} {Φ}_{q} \\ {ℱ}_{q} = {\text{?}}_{s} {Φ}_{q} + {ℒ}_{e q} p {Φ}_{q} + {ωℒ}_{e q} {Φ}_{d}\end{matrix} . \qquad ( 4 )$$

In Equation (4),

$${ℱ}_{d} = {Ni}_{d} + \frac{{ψ}_{f} {\text{?}}_{s}}{N}$$

and [symbol] =Ni_{q} are defined as the magnetomotive forces in the d-q coordinate system; Φ_{d} and Φ_{q} are defined as the magnetic fluxes in the d-q coordinate system; i_{d} and i_{q} are defined as the currents in the d-q coordinate system;

$${\text{?}}_{s} = \frac{{N}^{2}}{{L}_{s}}$$

is defined as the reluctance in the d-q coordinate system; [symbol] is defined as the equivalent magductance in the d-q coordinate system; Lₛ is defined as the inductance in the d-q coordinate system; ψ_{f} is defined as the permanent magnet flux linkage; ω is defined as the rotor electrical angular velocity; N is defined as the number of turns of the armature winding; and p is defined as a differential operator.

When the motor operates stably, the d-axis and q-axis magnetic circuits are assumed to be in a steady state, and the following equations can be obtained further:

$$\{ \begin{matrix}{L}_{s} {i}_{d} + {ψ}_{f} = - ω {kL}_{s} {ψ}_{q} + {ψ}_{d} \\ {L}_{s} {i}_{q} = ω k {L}_{s} {ψ}_{d} + {ψ}_{q}\end{matrix} . \qquad ( 5 )$$

By combining Equation (3) and Equation (5), the flux linkage equations of the SPMSM based on the vector magnetic circuit in the d-q coordinate system can be obtained:

$$[ \begin{matrix}1 & - tan δ \\ tan δ & 1\end{matrix} ] [ \begin{matrix}{ψ}_{d} \\ {ψ}_{q}\end{matrix} ] = [ \begin{matrix}{L}_{s} & 0 \\ 0 & {L}_{s}\end{matrix} ] [ \begin{matrix}{i}_{d} \\ {i}_{q}\end{matrix} ] + [ \begin{matrix}{ψ}_{f} \\ 0\end{matrix} ] . \qquad ( 6 )$$

Furthermore, two sides of Equation (6) are multiplied by cos δ, and the following expression can be obtained:

$${T}_{δ}^{′} [ \begin{matrix}{ψ}_{d} \\ {ψ}_{q}\end{matrix} ] = [ \begin{matrix}{L}_{s} cos δ & 0 \\ 0 & {L}_{s} cos δ\end{matrix} ] [ \begin{matrix}{i}_{d} \\ {i}_{q}\end{matrix} ] + [ \begin{matrix}{ψ}_{f} cos δ \\ 0\end{matrix} ] . \qquad ( 7 )$$

In Equation (7),

$${T}_{δ}^{′} = [ \begin{matrix}cos δ & - sin δ \\ sin δ & cos δ\end{matrix} ]$$

is defined as the R-L coordinate transformation matrix, which is used to rotate the d-q coordinate system toward the lagging direction by the magnetic impedance angle δ, and a new coordinate system, namely the R-L coordinate system, is obtained. The R-L coordinate system lags behind the d-q coordinate system by the angle δ.

In Equations (5)-(7), ψ_{d} and ψ_{q} are defined as the flux linkages in the d-q coordinate system; i_{d} and i_{q} are defined as the currents in the d-q coordinate system; Lₛ is defined as the inductance in the d-q coordinate system; ψ_{f} is defined as the permanent magnet flux linkage; and ω is defined as the rotor electrical angular velocity.

The d-axis and q-axis voltages (flux linkages) are transformed by

$${T}_{δ}^{′}$$

to obtain the R-axis and L-axis voltages (flux linkages), and the flux linkage equation of the SPMSM based on the vector magnetic circuit and the R-L coordinate system can be obtained further:

$$[ \begin{matrix}ψ \text{?} \\ {ψ}_{ℒ}\end{matrix} ] = [ \begin{matrix}{L}_{s} cos δ & 0 \\ 0 & {L}_{s} cos δ\end{matrix} ] [ \begin{matrix}{i}_{d} \\ {i}_{q}\end{matrix} ] + [ \begin{matrix}{ψ}_{f} cos δ \\ 0\end{matrix} ] . \qquad ( 8 )$$

The voltage equation of the SPMSM in the R-L coordinate system is given by:

$$[ \begin{matrix}u \text{?} \\ {u}_{ℒ}\end{matrix} ] = [ \begin{matrix}{R}_{s} & 0 \\ 0 & {R}_{s}\end{matrix} ] [ \begin{matrix}i \text{?} \\ {i}_{ℒ}\end{matrix} ] + [ \begin{matrix}p ψ \text{?} \\ p {ψ}_{ℒ}\end{matrix} ] + [ \begin{matrix}- {ωψ}_{ℒ} \\ ωψ \text{?}\end{matrix} ] . \qquad ( 9 )$$

Furthermore, according to a relation of

$$[ \begin{matrix}i \text{?} \\ {i}_{ℒ}\end{matrix} ] = {T}_{δ}^{′} [ \begin{matrix}{i}_{d} \\ {i}_{q}\end{matrix} ]$$

and Equation (8), the R-axis and L-axis currents are replaced by the d-axis and q-axis currents, and the R-axis and L-axis flux linkages are expressed by the d-axis and q-axis currents. From Equation (9), the following equation can be derived:

$$[ \begin{matrix}u \text{?} \\ {u}_{ℒ}\end{matrix} ] = [ \begin{matrix}{R}_{s} cos δ + {pL}_{s} cos δ & - ( {R}_{s} sin δ + ω {L}_{s} cos δ ) \\ {R}_{s} sin δ + ω {L}_{s} cos δ & {R}_{s} cos δ + p {L}_{s} cos δ\end{matrix} ] [ \begin{matrix}{i}_{d} \\ {i}_{q}\end{matrix} ] + [ \begin{matrix}0 \\ ω {ψ}_{f} cos δ\end{matrix} ] . \qquad ( 10 )$$

Since Rₛ sin δ<<ωLₛ cos δ, the term Rₛ sin δ in Equation (10) is neglected. Based on Equation (10), the voltage equation of the SPMSM based on the vector magnetic circuit and the R-L coordinate system is obtained:

$$\frac{1}{cos δ} [ \begin{matrix}u \text{?} \\ {u}_{ℒ}\end{matrix} ] = [ \begin{matrix}{R}_{s} + {pL}_{s} & - ω {L}_{s} \\ ω {L}_{s} & {R}_{s} + {pL}_{s}\end{matrix} ] [ \begin{matrix}{i}_{d} \\ {i}_{q}\end{matrix} ] + [ \begin{matrix}0 \\ ω {ψ}_{f}\end{matrix} ] . \qquad ( 11 )$$

The voltage terms on the left-hand side of Equation (10) are expressed in the d-q coordinate system, and the voltage equation of the SPMSM based on the vector magnetic circuit in the d-q coordinate system can be obtained:

$$[ \begin{matrix}1 & - tan δ \\ tan δ & 1\end{matrix} ] [ \begin{matrix}{u}_{d} \\ {u}_{q}\end{matrix} ] = [ \begin{matrix}{R}_{s} + {pL}_{s} & - ω {L}_{s} \\ ω {L}_{s} & {R}_{s} + {pL}_{s}\end{matrix} ] [ \begin{matrix}{i}_{d} \\ {i}_{q}\end{matrix} ] + [ \begin{matrix}0 \\ {ωψ}_{f}\end{matrix} ] . \qquad ( 12 )$$

Inverse Clark transformation is applied to Equation (12), and the voltage equation of the SPMSM based on the vector magnetic circuit in the a-β coordinate system can be obtained:

$$[ \begin{matrix}1 & - tan δ \\ tan δ & 1\end{matrix} ] [ \begin{matrix}{u}_{α} \\ {u}_{β}\end{matrix} ] = [ \begin{matrix}{R}_{s} + {pL}_{s} & 0 \\ 0 & {R}_{s} + {pL}_{s}\end{matrix} ] [ \begin{matrix}{i}_{α} \\ {i}_{β}\end{matrix} ] + [ \begin{matrix}- {ωψ}_{f} sin θ \\ {ωψ}_{f} cos θ\end{matrix} ] . \qquad ( 13 )$$

In Equations (8) (13) [symbol] and [symbol] are defined as the flux linkages in the R-L coordinate system; [symbol] and [symbol] are defined as the voltages in the R-L coordinate system; u_{d} and u_{q} are defined as the voltages in the d-q coordinate system; u_{α} and u_{β} are defined as the voltages in the a-β coordinate system; i_{d} and i_{q} are defined as the currents in the d-q coordinate system; i_{d} and i_{q} are defined as the currents in the a-β coordinate system; Lₛ is defined as the inductance in the d-q coordinate system; Rₛ is defined as the resistance in the d-q coordinate system; ψ_{f} is defined as the permanent magnet flux linkage; δ is defined as the magnetic impedance angle; ω is defined as the rotor electrical angular velocity; θ is defined as the rotor electrical position angle; and p is defined as the differential operator.

In step 3: a sensorless control method for the SPMSM based on the vector magnetic circuit and the R-L coordinate system is established.

According to the analysis model of the SPMSM established based on the vector magnetic circuit and the R-L coordinate system, a sensorless control method based on the vector magnetic circuit and the R-L coordinate system is designed as follows:

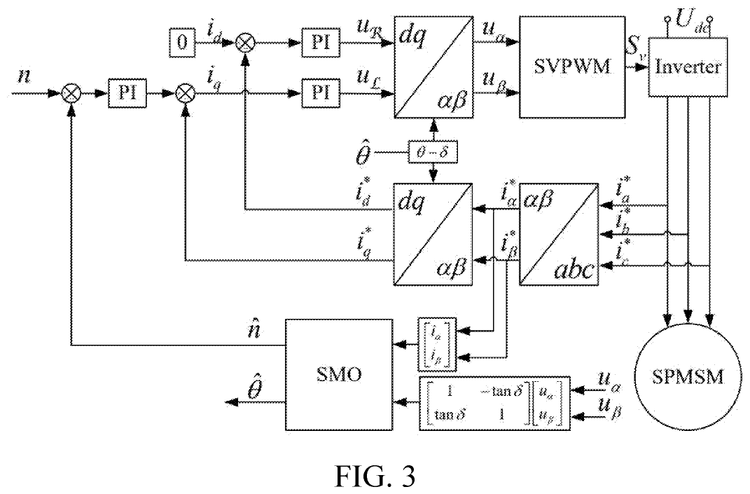

The cooperative working process of each module is shown in FIG. 3. Sampling is performed on the three-phase currents of the motor to obtain the sampling values

$${i}_{a}^{*} , {i}_{b}^{*} and {i}_{c}^{*} .$$

The sampling values

$${i}_{a}^{*} , {i}_{b}^{*} and {i}_{c}^{*}$$

are processed by the Clark transformation module (abc/α-β) to obtain the current sampling values

$${i}_{α}^{*} and {i}_{β}^{*}$$

in the a-β coordinate system, and

$${i}_{α}^{*} and {i}_{β}^{*}$$

are processed by the Park transformation module (α-β/dq) to obtain the current sampling values

$${i}_{d}^{*} and {i}_{q}^{*}$$

in the d-q coordinate system. The error between the rotor speed and the speed set value is processed by a proportional-integral (PI) controller to obtain the d-axis and q-axis current set values i_{d} and i_{q}. The errors between

$${i}_{d}^{*}$$

with

$${i}_{q}^{*}$$

and i_{d} with i_{q} are input into two PI controllers, and the voltage set values [symbol] and [symbol] in the R-L coordinate system are obtained. Based on the angle \hat{θ}−δ, the voltage set values u_{α} and u_{β} in the α-β coordinate system are obtained through the inverse Park transformation module (dq/ab). The voltage space vector is synthesized with u_{α} and u_{β}, and is input into the space vector pulse width modulation module (SVPWM) for modulation. The state coding values of the three half-bridges at this moment are output to control the MOS tube switches of the three-phase inverter to drive the motor. The rotor speed and rotor position angle used herein are provided by the rotor position and sliding mode observer (SMO).

The inverse Park transformation module in the present disclosure is used to transform the voltages in the R-L coordinate system into the voltages in the α-β coordinate system. The angle input to the inverse Park transformation module is the observed rotor position angle \hat{θ} minus the magnetic impedance angle δ, i.e., \hat{θ}−δ.

The rotor position and SMO in the present disclosure are designed according to Equation (13). The voltage information input to the rotor position and SMO is

$$[ \begin{matrix}1 & - tan δ \\ tan δ & 1\end{matrix} ] [ \begin{matrix}{u}_{α} \\ {u}_{β}\end{matrix} ] .$$

Sensorless vector control simulation is performed on the SPMSM. The motor speed is adjusted to 1,200 r/min with a load of 7.7 N·m, increased to 3,000 r/min, and the load is further reduced by 2 N·m. The step response speed and the stability of the current waveform are observed, and the effect of the control method of the present disclosure is compared with that of the conventional vector control method. The rotor position and speed information are identified when the SPMSM is controlled to operate at 1,200 r/min and 3,000 r/min. The sensorless control based on the model of the present disclosure is compared with the conventional sensorless control. The errors between the observed rotor position with speed information and the actual values are compared to verify the feasibility and effectiveness of the proposed motor analysis model and control method. The parameters of the SPMSM in the simulation are shown in the following table: The parameters of the SPMSM in the simulation are shown in the following table:

| Parameter | Value | | Parameter | Value | |
|---|---|---|---|---|---|
| Stator resistance Rₛ | 0.505 | Ω | Permanent magnet | 0.1326 | Wb |
| | | | flux linkage ψ_{f} | | |
| d-axis inductance L_{d} | 0.0015 | H | Direct current (DC) | 311 | V |
| | | | bus voltage U_{dc} | | |
| q-axis inductance L_{q} | 0.0015 | H | Rated line voltage Uₙ | 220 | V |
| Equivalent magductance | 0.005/Ω | | Rated torque Tₙ | 7.7 | N · m |
| coefficient k | | | | | |
| Number of pole pairs p | 4 | | Rated speed Nₙ | 2,500 | r/min |
| Moment of inertia J | 0.0015 | kg · m² | Rated power Pₙ | 2 | kW |

As shown in FIG. 4, with i_{d}=0 control and constant i_{d}, in the process of speed regulation and load reduction, the vector control proposed in the present disclosure exhibits smaller i_{d} fluctuations, and improves the speed and stability of the vector control in response to step changes.

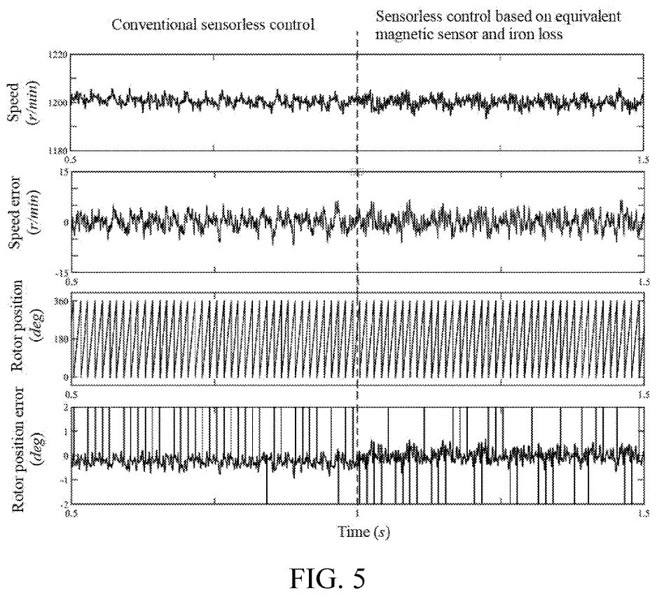

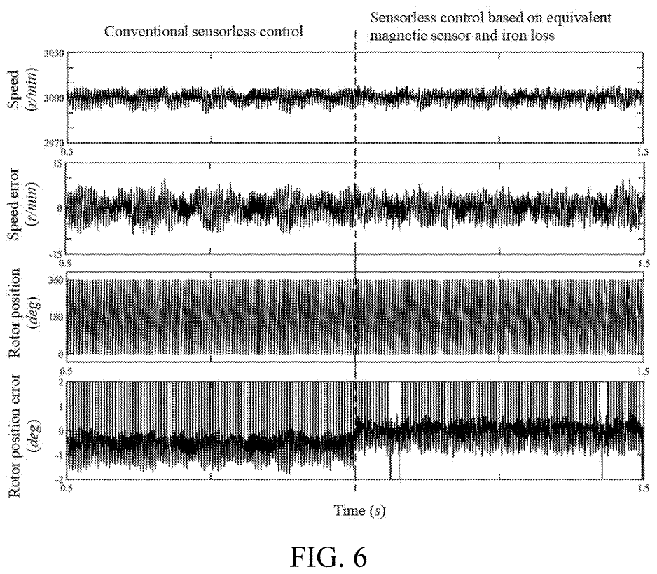

As shown in FIG. 5 and FIG. 6, compared with the conventional sensorless control, the sensorless control based on the model of the present disclosure improves the observation accuracy of the rotor position. The error is reduced by approximately 0.2 electrical degrees at 1,200 r/min, and by approximately 0.7 electrical degrees at 3,000 r/min. By comparing FIG. 5 and FIG. 6, it can be seen that higher speed corresponds to higher iron loss, which leads to larger estimation errors in the conventional sensorless control, while the sensorless control based on the model of the present disclosure achieves a better error reduction effect.

The examples of the present disclosure have been described above with reference to the drawings, without limiting the scope of the present disclosure. It is to be understood that various variations and improvements may be made by those skilled in the art without departing from the design spirit of the present disclosure, and all such variations and improvements to the technical solution of the present disclosure fall within the scope of protection defined by the appended claims of the present disclosure.

1. An establishment method for an analysis model of a surface permanent magnet synchronous motor (SPMSM), comprising the steps of: introducing magductance [symbol] and hysteretance C into direct-axis (d-axis) and quadrature-axis (q-axis) magnetic circuit models of an SPMSM to construct d-axis and q-axis vector magnetic circuit models; and taking an arctangent of a ratio between equivalent magnetic inductive reactance ω [symbol] and reluctance [symbol] as a magnetic impedance angle δ of the SPMSM;
the equivalent magnetic inductive reactance ω [symbol] being expressed as:
$${ωℒ}_{eq} = ωℒ + \frac{1}{ω C} ;$$
where ω is an electrical angular velocity of a rotor;
proposing an R-L coordinate system and an R-L coordinate transformation matrix
$${T}_{δ}^{′} ;$$
the R-L coordinate system lagging behind a direct-quadrature (d-q) coordinate system by a magnetic impedance angle δ; and transforming the d-q coordinate system into the R-L coordinate system by the R-L coordinate transformation matrix
$${T}_{δ}^{′} ;$$
and
establishing an analysis model of the SPMSM based on a vector magnetic circuit and the R-L coordinate system, comprising flux linkage equations and voltage equations based on the vector magnetic circuit and the R-L coordinate system.

2. The establishment method for an analysis model of an SPMSM according to claim 1, wherein the magnetic impedance angle δ of the SPMSM is expressed as:
$$δ = arctan ( \frac{{ωℒ}_{eq}}{\text{?}} ) = arctan ( \frac{ωℒ + \frac{1}{ω C}}{\text{?}} ) \qquad ( 1 )$$
an expression is defined as:
$$k = \frac{{ℒ}_{eq}}{{N}^{2}} = \frac{ℒ + \frac{1}{{ω}^{2} C}}{{N}^{2}} \qquad ( 2 )$$
where k is an equivalent magductance coefficient, since the reluctance is expressed as
$$\text{?} = \frac{{N}^{2}}{{L}_{s}} ;$$
the magnetic impedance angle of the SPMSM is expressed as:
$$δ = arctan ( ω {L}_{s} k ) \qquad ( 3 )$$
where [symbol] is magductance in the d-q coordinate system, C is hysteretance in the d-q coordinate system, [symbol] is equivalent magductance in the d-q coordinate system, [symbol] is reluctance in the d-q coordinate system, Lₛ is inductance in the d-q coordinate system, k is the equivalent magductance coefficient, δ is the magnetic impedance angle, ω is the electrical angular velocity of the rotor, and N is the number of turns of armature winding.

3. The establishment method for an analysis model of an SPMSM according to claim 2, wherein the R-L coordinate transformation matrix
$${T}_{δ}^{′}$$
is expressed as:
$${T}_{δ}^{′} = [ \begin{matrix}cos δ & - sin δ \\ sin δ & cos δ\end{matrix} ] .$$

4. The establishment method for an analysis model of an SPMSM according to claim 3, wherein a flux linkage equation of the SPMSM based on a vector magnetic circuit in the d-q coordinate system is obtained as:
$$[ \begin{matrix}1 & - tan δ \\ tan δ & 1\end{matrix} ] [ \begin{matrix}{ψ}_{d} \\ {ψ}_{q}\end{matrix} ] = [ \begin{matrix}{L}_{s} & 0 \\ 0 & {L}_{s}\end{matrix} ] [ \begin{matrix}{i}_{d} \\ {i}_{q}\end{matrix} ] + [ \begin{matrix}{ψ}_{f} \\ 0\end{matrix} ] \qquad ( 6 )$$
two sides of Equation (6) are multiplied by cos δ, and the flux linkage equation of the SPMSM based on the vector magnetic circuit in the d-q coordinate system is also written as:
$${T}_{δ}^{′} [ \begin{matrix}{ψ}_{d} \\ {ψ}_{q}\end{matrix} ] = [ \begin{matrix}{L}_{s} cos δ & 0 \\ 0 & {L}_{s} cos δ\end{matrix} ] [ \begin{matrix}{i}_{d} \\ {i}_{q}\end{matrix} ] + [ \begin{matrix}{ψ}_{f} cos δ \\ 0\end{matrix} ] \qquad ( 7 )$$
d-axis and q-axis flux linkages are transformed by the R-L coordinate transformation matrix
$${T}_{δ}^{′}$$
to obtain R-axis and L-axis flux linkages; and
$$[ \begin{matrix}{ψ}_{\text{?}} \\ {ψ}_{ℒ}\end{matrix} ] = {T}_{δ}^{′} [ \begin{matrix}{ψ}_{d} \\ {ψ}_{q}\end{matrix} ]$$
from Equation (7), a flux linkage equation of the SPMSM based on the vector magnetic circuit and the R-L coordinate system is obtained as:
$$[ \begin{matrix}ψ \text{?} \\ {ψ}_{ℒ}\end{matrix} ] = [ \begin{matrix}{L}_{s} cos δ & 0 \\ 0 & {L}_{s} cos δ\end{matrix} ] [ \begin{matrix}{i}_{d} \\ {i}_{q}\end{matrix} ] + [ \begin{matrix}{ψ}_{f} cos δ \\ 0\end{matrix} ] . \qquad ( 8 )$$

5. The method for establishing an analysis model of an SPMSM according to claim 4, wherein a voltage equation of the SPMSM in the R-L coordinate system is as follows:
$$[ \begin{matrix}ψ \text{?} \\ {ψ}_{ℒ}\end{matrix} ] = [ \begin{matrix}{R}_{s} & 0 \\ 0 & {R}_{s}\end{matrix} ] [ \begin{matrix}i \text{?} \\ {i}_{ℒ}\end{matrix} ] + [ \begin{matrix}p ψ \text{?} \\ p {ψ}_{ℒ}\end{matrix} ] + [ \begin{matrix}- {ωψ}_{ℒ} \\ ωψ \text{?}\end{matrix} ] \qquad ( 9 )$$
R-axis and L-axis currents are used to replace d-axis and q-axis currents according to a relation of
$$[ \begin{matrix}{i}_{ℛ} \\ {i}_{ℒ}\end{matrix} ] = {T}_{δ}^{′} [ \begin{matrix}{i}_{d} \\ {i}_{q}\end{matrix} ]$$
and Equation (8), and the R-axis and L-axis flux linkages are expressed by the d-axis and q-axis currents, which is obtained from Equation (9):
$$( 10 )$$
$$[ \begin{matrix}{u}_{ℛ} \\ {u}_{ℒ}\end{matrix} ] = [ \begin{matrix}{R}_{s} cos δ + {pL}_{s} cos δ & - {R}_{s} sin δ + ω {L}_{s} cos δ \\ {R}_{s} sin δ + ω {L}_{s} cos δ & {R}_{s} cos δ + {pL}_{s} cos δ\end{matrix} ] [ \begin{matrix}{i}_{d} \\ {i}_{q}\end{matrix} ] + [ \begin{matrix}0 \\ ω {ψ}_{f} cos δ\end{matrix} ]$$
since Rₛ sin δ<<ωLₛ cos δ, Rₛ sin δ in Equation (10) is neglected, and according to Equation (10), a voltage equation of the SPMSM based on the vector magnetic circuit and the R-L coordinate system is obtained as:
$$\frac{1}{cos δ} [ \begin{matrix}{u}_{ℛ} \\ {u}_{ℒ}\end{matrix} ] = [ \begin{matrix}{R}_{s} + {pL}_{s} & - ω {L}_{s} \\ ω {L}_{s} & {R}_{s} + {pL}_{s}\end{matrix} ] [ \begin{matrix}{i}_{d} \\ {i}_{q}\end{matrix} ] + [ \begin{matrix}0 \\ ω {ψ}_{f}\end{matrix} ] \qquad ( 11 )$$
where [symbol] and [symbol] are flux linkages in the R-L coordinate system, [symbol] and [symbol] are voltages in the R-L coordinate system, [symbol] and [symbol] are currents in the R-L coordinate system, Lₛ is the inductance in the d-q coordinate system, Rₛ is resistance in the d-q coordinate system, ψ_{f} is permanent magnet flux linkage, δ is the magnetic impedance angle, ω is the electrical angular velocity of the rotor, and p is a differential operator.

6. The method for establishing an analysis model of an SPMSM according to claim 5, wherein a voltage term on a left side of Equation (10) is expressed in the d-q coordinate system, and a voltage equation of the SPMSM based on the vector magnetic circuit in the d-q coordinate system is obtained as:
$$[ \begin{matrix}1 & - tan δ \\ tan δ & 1\end{matrix} ] [ \begin{matrix}{u}_{d} \\ {u}_{q}\end{matrix} ] = [ \begin{matrix}{R}_{s} + {pL}_{s} & - ω {L}_{s} \\ ω {L}_{s} & {R}_{s} + {pL}_{s}\end{matrix} ] [ \begin{matrix}{i}_{d} \\ {i}_{q}\end{matrix} ] + [ \begin{matrix}0 \\ ω {ψ}_{f}\end{matrix} ] \qquad ( 12 )$$
an inverse Clark transformation is performed on Equation (12), and a voltage equation of the SPMSM based on the vector magnetic circuit in an α-β coordinate system is obtained as:
$$[ \begin{matrix}1 & - tan δ \\ tan δ & 1\end{matrix} ] [ \begin{matrix}{u}_{α} \\ {u}_{β}\end{matrix} ] = [ \begin{matrix}{R}_{s} + {pL}_{s} & 0 \\ 0 & {R}_{s} + {pL}_{s}\end{matrix} ] [ \begin{matrix}{i}_{α} \\ {i}_{β}\end{matrix} ] + [ \begin{matrix}- ω {ψ}_{f} sin θ \\ ω {ψ}_{f} cos θ\end{matrix} ] \qquad ( 13 )$$
where i_{α} and i_{β} are currents in the α-β coordinate system, u_{d} and u_{q} are voltages in the d-q coordinate system, and θ is an electrical angle of a rotor position.

7. A control method for the surface permanent magnet synchronous motor (SPMSM), wherein an analysis model of the SPMSM is established based on the establishment method according to claim 6, and the control method comprises the steps of:
sampling three-phase currents of the motor to obtain sampling values
$${i}_{a}^{*} , {i}_{b}^{*} , and {i}_{c}^{*}$$
passing
$${i}_{a}^{*} , {i}_{b}^{*} , and {i}_{c}^{*}$$
through a Clark transformation module to obtain current sampling values
$${i}_{α}^{*} and {i}_{β}^{*}$$
in the α-β coordinate system, and passing
$${i}_{α}^{*} and {i}_{β}^{*}$$
through a Park transformation module to obtain current sampling values
$${i}_{d}^{*} and {i}_{q}^{*}$$
in the direct-quadrature (d-q) coordinate system; processing an error between an observed rotor speed value \hat{n} and a set value n through a proportional-integral (PI) controller to obtain direct-axis (d-axis) and quadrature-axis (q-axis) current set values i_{d} and i_{q}, inputting errors between
$${i}_{d}^{*}$$
with
$${i}_{q}^{*}$$
and i_{d} will i_{q} into two PI controllers to obtain voltage set values [symbol] and [symbol] in the R-L coordinate system; performing an inverse Park transformation via an inverse Park transformation module based on an angle \hat{θ}−δ, transforming the voltage set values [symbol] and [symbol] in the R-L coordinate system to obtain voltage set values u_{α} and u_{β} in the α-β coordinate system; and synthesizing a voltage space vector using u_{α} and u_{β}, inputting the voltage space vector into a space vector pulse width modulation (SVPWM) module for modulation, outputting state coding values of three half-bridges, and controlling metal-oxide-semiconductor field-effect transistor (MOSFET) switches of a three-phase inverter to control the motor, where \hat{θ} is an observed rotor position angle value.

8. The control method for the motor according to claim 7, comprising the steps of: outputting the observed rotor speed value \hat{n} and the observed rotor position angle value \hat{θ} from a rotor position and sliding mode observer (SMO);
inputting a voltage
$$[ \begin{matrix}1 & - tan δ \\ tan δ & 1\end{matrix} ] [ \begin{matrix}{u}_{α} \\ {u}_{β}\end{matrix} ]$$
into the rotor position and SMO; and
inputting current sampling values
$${i}_{α}^{*} and {i}_{β}^{*}$$
in the α-β coordinate system into the rotor position and SMO.
